(19) United States
(12) Patent Application Publication
(10) Pub. No.: US 2017/0337561 A1
(43) Pub. Date: Nov. 23, 2017

(54) COLLABORATIVE SOFTWARE PLATFORM TO SUPPORT PROFESSIONAL SERVICES

(71) Applicant: MoneyGuide Advisory, Inc., Powhatan, VA (US)

(72) Inventors: Robert D. CURTIS, Powhatan, VA (US); Antonio B. LEAL, Glen Allen, VA (US)

(21) Appl. No.: 15/524,977

(22) PCT Filed: Nov. 6, 2015
(86) PCT No.: PCT/US2015/059578

§ 371 Date: May 5, 2017

Related U.S. Application Data
(60) Provisional application No. 62/076,960, filed on Nov. 7, 2014.

(51) Int. Cl. G06Q 30/00; G06F 9/44; G06F 9/445; G06F 17/30

(52) U.S. Cl. CPC G06Q 30/016; G06F 17/30867; G06F 17/30522; G06F 9/4443; G06F 9/4451; G06F 17/30377

(57) ABSTRACT

Systems, methods, and computer program embodiments are disclosed for providing a collaborative software platform to support professional services. In an embodiment, profile data associated with a user may first be received. The received profile data may include user preference data or user demographic data. Application data associated with the user may then be retrieved from an application database. The application database may store user-specific data to support an interactive application provided by the collaborative software platform. An interface configuration file may be identified based on the received profile data, and the interactive application may be customized according to the identified interface configuration file. Finally, the interactive application may be presented for display to the user.

### CROSS REFERENCE TO RELATED APPLICATIONS

This application claims the benefit of U.S. Provisional Patent Application No. 62/076,960, filed Nov. 7, 2014, titled “SYSTEMS AND METHODS FOR PROVIDING FINANCIAL PLANNING SERVICES,” which is hereby incorporated herein by reference in its entirety.

### BACKGROUND

### Field

This disclosure generally relates to collaborative software and applications thereof.

### Background

Professional services often make use of customized software to store client information and perform service-related tasks. For example, financial advisors may use professional financial software to develop a financial plan tailored to each client. Similarly, an accountant may use customized software to prepare taxes or financial statements for clients, or a digital presence service provider may use professional software to build websites for and provide marketing services to clients. These services generally come at a high initial cost to the consumer, and professional service providers may incur significant overhead in collecting consumer information and service needs. Furthermore, consumers are often uneducated about the services desired, and thus rely on the service provider to infer and recommend services and strategies.

Additionally, this approach to professional services is not efficiently scalable due to a limited number of trained professionals. Consumers are generally unable or restricted from using the professional software, and as a result, scalability and personnel load lies strictly on the number of available service professionals. Technological improvements are, in turn, restricted to their effect on individual efficiencies.

In response to drawbacks associated with this traditional approach to professional services, consumer-facing, do-it-yourself software can reduce the barrier to entry for a consumer. This type of software is intended to allow consumers to accomplish tasks traditionally done by professional service providers, while reducing initial and overall costs. For example, personal financial planning tools may enable a consumer to develop a retirement plan without contacting a financial advisor. While these tools may provide minimal education to the consumer, significant time on the part of the consumer is typically required, and the quality of results is difficult to verify. Consumers may not understand all required inputs to the software or how to operate each feature, and only minimal support may be made available. Also, the software may be targeted toward consumers generally, and therefore may not target the information most important to a particular individual.

Additionally, to reduce costs to the consumer, support is generally limited to technical matters or very limited contact with a professional. This approach also reduces the potential client base for professional service providers. Furthermore, user data is often formatted and stored according to a schema specified by the consumer-facing software, and exporting this data for use by a professional service provider may present significant challenges.

### SUMMARY

The present invention provides a solution that bridges the gap between the traditional professional services approach and do-it-yourself software by minimizing initial costs and confusion to the consumer while encouraging collaboration between the consumer and professional service provider. Systems, methods, and computer program embodiments are disclosed for providing a collaborative software platform to support professional services. In an embodiment, profile data associated with a user may first be received. The received profile data may include user preference data or user demographic data. Application data associated with the user may then be retrieved from an application database. The application database may store user-specific data to support an interactive application provided by the collaborative software platform. An interface configuration file may be identified based on the received profile data, and the interactive application may be customized according to the identified interface configuration file. Finally, the interactive application may be presented for display to the user.

In an embodiment, the interactive software may be presented alongside educational media and technical support services. The educational media may include at least one of streaming video and audio and may be retrieved based on a current state of the interactive software.

Further embodiments, features, and advantages of the invention, as well as the structure and operation of the various embodiments, are described in detail below with reference to accompanying drawings.

### BRIEF DESCRIPTION OF THE DRAWINGS

The accompanying drawings, which are incorporated herein and form part of the specification, illustrate the present disclosure and, together with the description, further serve to explain the principles of the disclosure and to enable a person skilled in the relevant art to make and use the disclosure.

FIG. 1 is a diagram illustrating an example existing configuration for providing professional services to consumers, according to an embodiment.

FIG. 2 is a diagram illustrating another example existing configuration for providing professional services to consumers, according to an embodiment.

FIG. 3 is a diagram illustrating an example system for providing a collaborative software platform to support professional services, according to an embodiment.

FIG. 4 is a diagram illustrating an example interface for providing interactive tools to consumers to support professional services, according to an embodiment.

FIG. 5 is an example method for accessing a collaborative software platform, according to an embodiment.

FIG. 6 is an example method for sharing user data with a professional service provider, according to an embodiment.

FIG. 7 is a diagram illustrating an example interface for selecting a financial planning software lab, according to an embodiment.

FIG. 8 is a diagram further illustrating an example interface for scheduling a financial planning software lab, according to an embodiment.

FIG. 9 is a diagram illustrating an example interface for registering for a selected software lab, according to an embodiment.

FIG. 10 is a diagram further illustrating an example interface for accessing a scheduled software lab, according to an embodiment.

FIG. 11 is a diagram illustrating an example interface for creating and accessing a personalized financial plan, according to an embodiment.

FIG. 12 is a diagram further illustrating an example interface for creating a personalized financial plan, according to an embodiment.

FIG. 13 is a diagram further illustrating an example interface for creating a personalized financial plan, according to an embodiment.

FIG. 14 is a diagram further illustrating an example interface for creating a personalized financial plan, according to an embodiment.

FIG. 15 is a diagram further illustrating an example interface for creating a personalized financial plan, according to an embodiment.

FIG. 16 is a diagram further illustrating an example interface for creating a personalized financial plan, according to an embodiment.

FIG. 17 is a diagram further illustrating an example interface for creating a personalized financial plan, according to an embodiment.

FIG. 18 is a diagram further illustrating an example interface for creating a personalized financial plan, according to an embodiment.

FIG. 19 is a diagram further illustrating an example interface for creating a personalized financial plan, according to an embodiment.

FIG. 20 is a diagram further illustrating an example interface for creating a personalized financial plan, according to an embodiment.

FIG. 21 is a diagram further illustrating an example interface for creating a personalized financial plan, according to an embodiment.

FIG. 22 is a diagram further illustrating an example interface for creating a personalized financial plan, according to an embodiment.

FIG. 23 is a diagram further illustrating an example interface for creating a personalized financial plan, according to an embodiment.

FIG. 24 is a diagram illustrating an example interface for initiating collaboration with a professional services provider, according to an embodiment.

FIG. 25 is a diagram illustrating an example computing device, according to an embodiment.

The drawing in which an element first appears is typically indicated by the leftmost digit or digits in the corresponding reference number. In the drawings, like reference numbers may indicate identical or functionally similar elements.

### DETAILED DESCRIPTION

### Example Existing Configurations for Providing Professional Services

In the detailed description that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

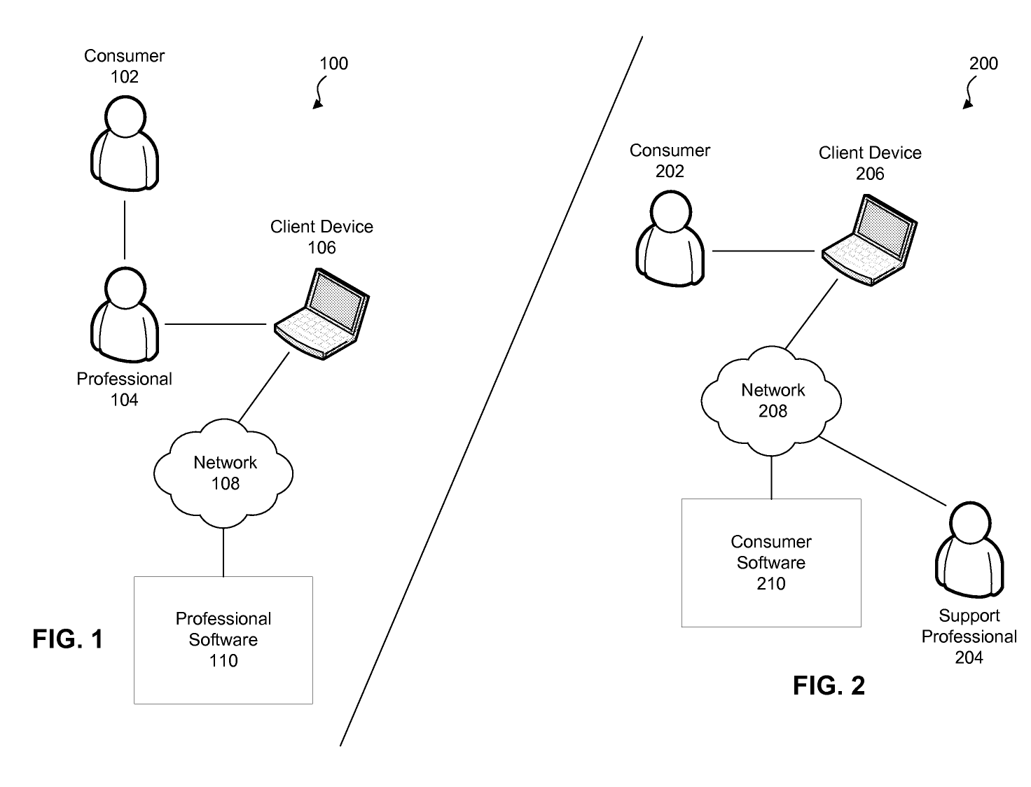

FIG. 1 is a diagram illustrating an example existing configuration for providing professional services to consumers, according to an embodiment. Configuration 100 includes a consumer 102, a service professional 104, a client device 106, a network 108, and professional software 110. Client device 106 may be coupled to network 108, and network 108 may be any type of computer network capable of communicating data, such as for example, a wired or wireless local area network or a wide area network (e.g., the Internet), or any combination thereof. Client device 106 may be any type of computing device, including, but not limited to, a desktop, laptop, or mobile device.

Configuration 100 depicts a conventional model currently used by professional service providers. In this configuration, consumer 102 may contact service professional 104 to request certain services. Service provider 104 may make use of professional software 110 to perform the requested services. In various configurations, professional software 110 may reside on client device 106 or accessed via network 108.

By way of example, consumer 102 may contact an accountant to perform tax related services, and the accountant may operate tax preparation software to perform the requested services. In this instance, consumer 102 does not have access to professional software 110, and the all consumer information must be entered by the accountant. Professional software 110 is generally targeted at accountants and professional service providers, and thus not intended for direct use by consumer 102.

The lack of control and high initial costs associated with employing service professional 104 may create a significant barrier to entry for consumer 102, and thus consumer 102 may be reluctant to make use of a professional service provider. Further, because professional software 110 is designed for service professionals, the software may not easily be adapted for use by consumer 102. Any initial work done by consumer 102 in an effort to reduce initial costs must still be translated by professional service providers for use with professional software 110. Additionally, configuration 100 cannot be efficiently scaled due to a limited number of trained service professionals. To reduce costs and risks associated with hiring a service professional, many companies have begun to offer consumer-facing software capable of performing tasks ordinarily offered by professional service providers, as will be described with respect to FIG. 2.

FIG. 2 is a diagram illustrating another example existing configuration for providing professional services to consumers, according to an embodiment. Configuration 200 includes a consumer 202, a client device 206, a network 208, consumer software 210, and a support professional 204. Client device 206 may be coupled to network 208, and network 208 may be any type of computer network capable of communicating data, such as for example, a wired or wireless local area network or a wide area network (e.g., the Internet), or any combination thereof. Client device 206 may be any type of computing device, including, but not limited to, a desktop, laptop, or mobile device.

Configuration 200 depicts another approach currently offered to consumers as an alternative to the conventional professional services model. In this configuration, consumer 202 may directly operate consumer software 210. In various embodiments, consumer software 210 may reside on client device 206 or accessed via network 208. Consumer software 210 may represent do-it-yourself software designed for use by consumers without the aid of a professional service provider. This software may be intended to provide convenience and guidance to consumer 202, while requiring only a small outlay of funds.

By way of example, consumer 202 may desire to prepare his or her taxes without incurring the cost of hiring an accountant or licensed tax preparer. Consumer software 210 may provide basic education and guidance to consumer 210, and support professional 204 may additionally be made available to consumer 202. In this configuration, support is generally restricted to technical support or very limited interaction with a service professional. This may reduce initial and overall costs to consumer 202, but the quality of results becomes difficult to verify as the consumer is not professionally trained.

For services such as, but not limited to, financial planning, a reduction in quality of results may create substantial problems for consumer 202 that greatly outweigh the cost of hiring a professional service provider. Further, because consumer software 210 is designed for use by consumers, the underlying data may not be easily transferred to professional software used by service professionals. This may decrease incentives to contact a service professional to verify results, as the costs may remain similar to those described with respect to FIG. 1.

### Example System

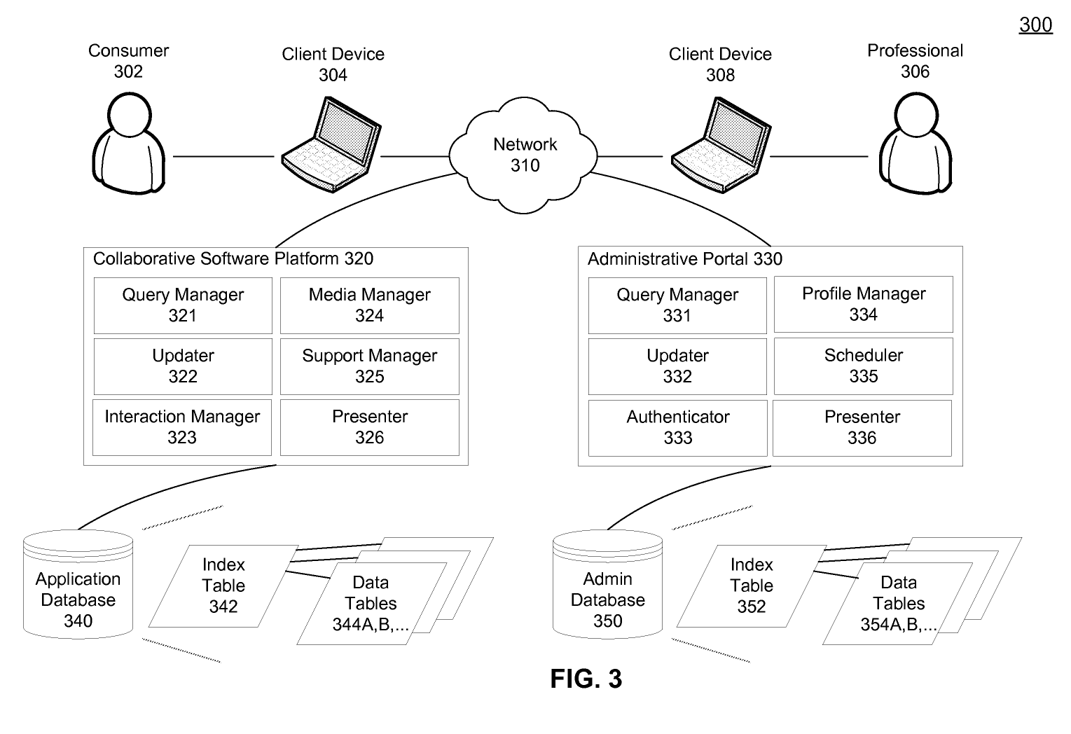

FIG. 3 is a diagram illustrating an example system 300 for providing a collaborative software platform to support professional services, according to an embodiment. System 300 addresses issues associated with the approaches described with respect to FIGS. 1 and 2 by bridging the gap between consumer-facing software and professional service providers. System 300 includes a consumer 302, a service professional 306, client devices 304 and 308, network 310, collaborative software platform 320, administrative portal 330, application database 340, and administrative database 350. Client devices 304 and 308 may be coupled to network 310, and network 310 may be any type of computer network capable of communicating data, such as for example, a wired or wireless local area network or a wide area network (e.g., the Internet), or any combination thereof. Client devices 304 and 308 may be coupled via network 310 to collaborative software platform 320 and administrative portal 330. Collaborative software platform 320 and administrative portal 330 may be implemented on the same or different servers located in the same or different locations. Each of collaborative software platform 320 and administrative portal 330 may be implemented on one or more servers located in the same or different locations.

In an embodiment, collaborative software platform 320 may support tasks traditionally performed by professional service providers. For example, collaborative software platform 320 may include financial planning tools used to develop financial plans for end consumers. In an embodiment, the software platform 320 may be accessed by both consumer 302 and service professional 306 via client devices 304 and 308, respectively, and network 310. Client devices 304 and 308 may each, for example, include a web browser that enables a user to interact with the collaborative software platform. The web browser may respond to user input by sending a hypertext transfer protocol (HTTP) request to collaborative software platform 320 via network 310. In another example, the user may interface with client device 304 or 308 through a native application instead of a web browser, such that the native application communicates with collaborative software platform 320. Client devices 304 and 308 may be any type of computing device, such as and without limitation, a desktop, laptop, or mobile device.

Collaborative software platform 320 may include query manager 321, updater 322, interaction manager 323, media manager 324, support manager 325, and presenter 326. In an embodiment, collaborative software platform 320 may be coupled to application database 340. Application database 340 may store user-specific application data used to support applications provided by collaborative software platform 320. For example, application database may store financial data and calculations for various consumers that represent generated financial plans. Application database may be any type of structured data store, including a relational, document-oriented, or object-oriented database.

As illustrated in FIG. 3, application database 340 may store the data in a plurality of different data tables 344A, B, . . . To improve performance of database queries and updates, application database 340 may also include an index table 342. In an embodiment, updater 322 may query index table 342 to assist with data insertions and updates, and query manager 321 may query index table 342 to assist with data retrieval. The index table may point to entries in data tables 344, which include complete individual data records. Or, in an embodiment where the database is de-normalized, the index table may itself include the individual data records in part or in full. In this way, index table 342 may be used to improve performance of database queries and updates.

In an embodiment, collaborative software platform 320 may include service-specific interactive software (e.g., financial planning software), educational media, and professional support. Interaction manager 323 may provide interactive software used to support particular professional services. Interaction manager 323 may communicate with query manager 321 and updater 322 to retrieve and update data in application database 340. Interaction manager 323 may also interact with presenter 326 to display a graphical user interface to an end user.

In an embodiment, interaction manager 323 may provide software adapted for different target audiences. For example, in the case of financial planning, interaction manager 323 may provide a different user interface and different features to consumer 302 and service professional 306. For instance, consumer 302 may access an interface designed to limit features and increase ease of use, while service professional 306 may access an interface that includes more complex software features. Interaction manager 323 may further provide a different user interface based on characteristics and demographics of each consumer 302, for example to retirees or individuals 20 years from retirement. This enables the provided software to be accessible by both consumers and professional service providers without creating distinct software products or versions.

While the user interface of the interactive software may be customized for each target audience, application data may be stored together in application database 340. This allows for application data to be accessed and shared among different end users, such as consumer 302 and service professional 306. Returning to financial planning by way of example, a consumer, such as consumer 302, may first interact with financial planning software provided by interaction manager 323 to develop a preliminary financial plan. This plan may then be shared with a financial advisor, such as professional 306, who may work with the consumer's financial data via interaction manager 323. Although the consumer and financial advisor may be presented with different interfaces, tools, and features, a shared data store (e.g., application database 340) enables the underlying data to be accessible to both users without requiring modification to the financial planning software.

In an embodiment, interaction manager 323 may identify and retrieve one or more interface configuration files targeted for a particular user based on user characteristics and demographics. Each configuration file may specify software tools, features, and/or interface pages to be available and displayed to the user. The user characteristics and demographics may be used to determine which information is most important to the user and which features should be made available for use. For example, college savings information may be particularly important to a consumer with young children, which may be used to identify configuration files specifying relevant interface pages to be displayed to the user. The software interface may then be customized based on the retrieved configuration files. For example, when a retired consumer accesses the financial planning software, the consumer may have access to retirement cash flow planning tools but not estate planning tools. Additionally, the consumer may not be shown interface pages related to employment income as the user is retired. In an embodiment, an interface configuration file may be created for each user, enabling the software to be customized specially for that user. In an embodiment, the configuration file may be formatted in JavaScript object notation (JSON) or as an extensible markup language (XML) document. In an embodiment, each configuration file may be stored in application database 340 or in another data store.

The interface configuration files may enable interactive software to be customized without the need to modify core application code. Various implemented tools, software features, and interface pages/elements may simply be presented and made available to the user. This permits rapid deployment of customized software to new customers and user types by creating new interface configuration files.

In an embodiment, media manager 324 may provide educational audio and/or video. For example, media manager 324 may provide instructional audio and/or video explaining the difference between various financial asset classes or guiding the user through provided financial software. In an embodiment, media manager 324 may retrieve educational media from application database 340 or another data store. Alternatively, media manager 324 may interact with a third party service to retrieve the appropriate media, for example via an application programming interface (API). In an embodiment, the educational media may provide basic education and guidance to untrained users, such as consumer 302, but may not be retrieved when the interactive software is accessed by a professional user, such as service professional 306. In various embodiments, the retrieved audio and/or video may be streamed or downloaded for playback.

In an embodiment, support manager 325 may provide interactive support to users of the software platform. In various embodiments, support manager may connect end users to technical support professionals or service-specific support professionals, and the support may occur in the form of chat, email, voice communication, video communication, or any combination thereof. For example, support manager 325 may connect consumer 302 to a technical support professional that can help the consumer enter employment income into provided financial planning software. In an embodiment, support manager 325 may make use of a third party service to provide the aforementioned support to users.

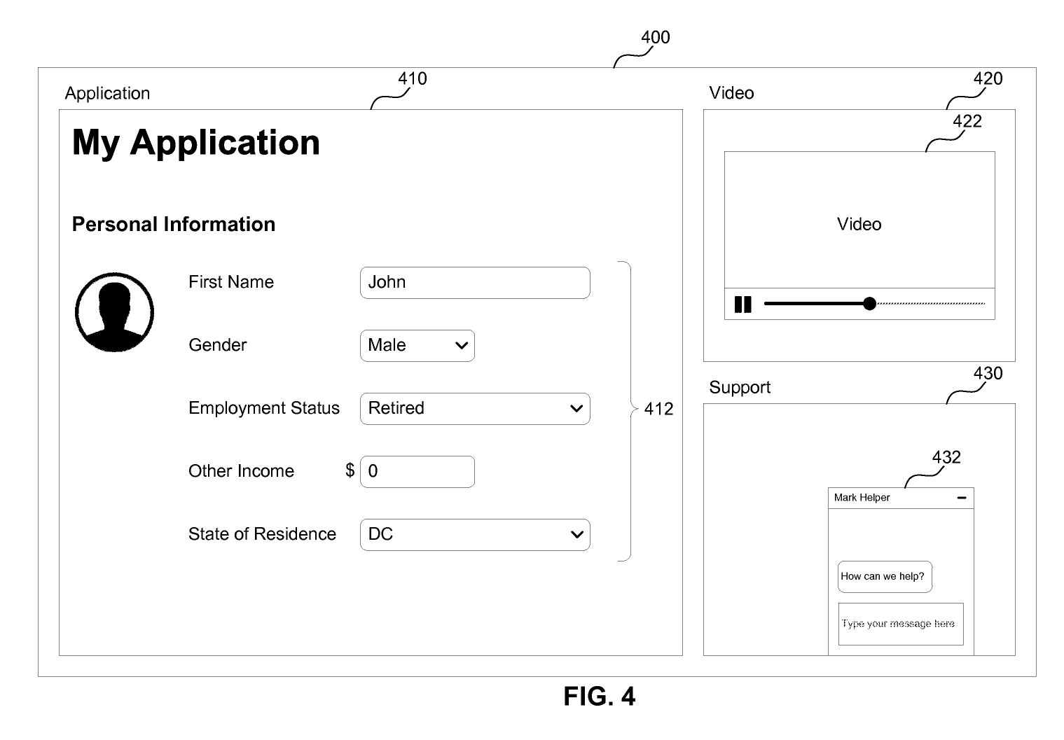

In an embodiment, presenter 326 may interact with interaction manager 323, media manager 324, and support manager 325 to present a user interface for display to an end user, such as consumer 302 or service professional 306. Presenter 326 may aggregate content retrieved by different components (e.g., interaction manager 323, media manager 324, and support manager 325) into a single, unified graphical user interface. In an embodiment, presenter 326 may use characteristics and demographics of a user to determine appropriate components to display to the user. For example, if a consumer, such as consumer 302, is accessing financial planning software, presenter 326 may display an associated educational video and chat support alongside the interactive financial planning tools. On the other hand, if a financial advisor, such as service professional 306, is accessing financial planning software, presenter 326 may omit associated educational media and chat support from the user interface. Presenter 326 may also relay information from one interface component to another. For example, interaction manager 323 may pass information about its current state to presenter 326, and presenter 326 may pass this information to media manager 324 to retrieve relevant educational media for display. An example unified user interface is described further with respect to FIG. 4.

In an embodiment, administrative portal 330 may provide administrative, scheduling, and general utility functions to support collaborative software platform 320. Administrative portal 330 may include query manager 331, updater 332, authenticator 333, profile manager 334, scheduler 335, and presenter 336. In an embodiment, administrative portal 330 may be coupled to administrative database 350. Administrative database 350 may store administrative data and user profile data associated with end users. User profile data may include various user preferences and demographics, for example and without limitation, age, gender, marital status, employment status, and income level. Administrative database may be any type of structured data store, including a relational, document-oriented, or object-oriented database.

As illustrated in FIG. 3, administrative database 350 may store the data in a plurality of different data tables 354A, B, . . . To improve performance of database queries and updates, administrative database 350 may also include an index table 352. In an embodiment, updater 332 may query index table 352 to assist with data insertions and updates, and query manager 331 may query index table 352 to assist with data retrieval. The index table may point to entries in data tables 354, which include complete individual data records. Or, in an embodiment where the database is de-normalized, the index table may itself include the individual data records in part or in full.

In an embodiment, administrative portal 330 may act as an entry point for end users (e.g. consumer 302 and service professional 306) accessing collaborative software platform 320. When a user first attempts to access administrative portal 330, authenticator 333 may receive an authentication request from the user, evaluate provided credentials, and authenticate the user. Once authenticated with administrative portal 330, the user may also gain access to collaborative software platform 320. In an embodiment, access to collaborative software platform 320 is accomplished using a single sign-on implementation, such as security assertion markup language (SAML) 2.0.

In an embodiment, profile manager 334 may receive user preference and demographic data from and end user. Profile manager 334 may then communicate with updater 332 to store the received user data in administrative database 350. When a user accesses collaborative software platform 320, according to an embodiment, profile manager 334 may retrieve user profile data from administrative database 350 via query manager 331. This retrieved data may then be passed to collaborative software platform for use in tailoring interactive software, media, and support to the user. Profile manager 334 may also receive marketing information from professional service providers, such as service professional 306. This information may be presented to consumers while using administrative portal 330.

In an embodiment, collaborative software platform 320 may only be accessible to users at particular times. For example, collaborative software may implement software labs for consumers, such as consumer 302. In an embodiment, a software lab offers consumer 302 access to interactive software, instructional media, and support services provided by collaborative software platform 320 during a scheduled time period. For example, in the case of financial planning services, consumer 302 may have access to financial planning software, instructional video, and chat support from 1:00 PM to 2:00 PM on Friday. Scheduler 335 may manage available lab schedules and enable an end user to schedule a time to participate in a lab. In an embodiment, lab schedules and participants may be stored in administrative database 350.

Software labs offer a number of benefits to consumer 302, service professional 306, and system collaborative software platform 320. First, the scheduling mechanism may convey a sense of urgency to consumer 302. If collaborative software platform 320 is always available, consumer 302 may be more inclined to procrastinate or delay software usage. A schedule and restriction of access may encourage software usage during the scheduled availability timeframe.

Second, support staff may be predictably staggered as the number of users connected to collaborative software platform 320 at any given time can be more easily anticipated. Finally, server load may be drastically reduced by spreading out software usage over a large period of time. Furthermore, server load may be predicted in advance based on stored schedules, and resources may be allocated appropriately in advance of peak usage times.

In an embodiment, consumer 302 may be invited to participate in a software lab by professional 306. For example, a financial advisor, such as service professional 306, may refer a potential client to collaborative software platform in hopes of gaining business. Professional 306 may designate a certain number of seats available for potential clients to participate in a software lab. Consumer 302 may be restricted from registering for a lab if the referrer does not have additional seats available. When consumer 302 completes a software lab, the results may be stored in application database 340 for future access. For example, if consumer 302 attends a software lab in which the consumer creates a basic, personalized financial plan, the plan may be written to application database 340. Once a plan has been created, the plan may be shared with the financial advisor for review at the consumer's request. Because the plan is stored in a shared data store, such as application database 340, the financial advisor may access the consumer's financial plan through his or her own access to collaborative software platform 320. This process may encourage consumer 302 to obtain the services of a professional service provider while minimizing up-front consumer costs and reducing data entry overhead for service professional 306.

In an embodiment, relevant statistics may be recorded by administrative portal 330 and stored in administrative database 350. For example, the number of consumers who participated in a particular lab and the number of those consumers that shared data with service professional 306 may be stored. These statistics may enable service professional 306 to monitor the effectiveness of different types of labs and business generation among users of different demographics.

In another embodiment, service professionals may be recommended to consumer 302 after completing a software lab. The recommended service professionals may be matched based on specialty or characteristics of the consumer's profile and/or plan. As previously described, consumer 302 may then choose to share his or her created financial plan with one of the recommended service professionals for review.

In an embodiment, professional service providers may host private instances of collaborative software platform 320 and application database 340 for increased security. In this case, data shared from the consumer-facing application database 340 may need to be copied to the privately hosted application database 340 of the professional service provider. A converter (not shown) may be responsible for the transfer of data from one data store to another. Additionally, the converter may include custom logic to normalize data to the privately hosted application database 340 if data schemas differ between the two instances. For example, a financial advisor may work with a number of asset classes when creating financial plans. In contrast, a consumer may only have access to stocks, bonds, and cash when creating a basic financial plan. This difference may be reflected in the underlying data schema for each instance of application database 340. When a consumer's financial plan is copied to the privately hosted application database 340, the converter may ensure the financial plan data conforms to the new data schema.

In an embodiment, presenter 336 may interact with each component of administrative portal 330 to provide a graphical user interface to end users, such as consumer 302 and service professional 306. The user interface may aggregate data stored in administrative database 350 for display to a user and provide links to access collaborative software platform 320.

### Example User Interface

FIG. 4 is a diagram illustrating an example interface 400 for providing interactive tools to consumers to support professional services, according to an embodiment. Interface 400 includes application frame 410, video frame 420, and support frame 430. In various embodiments, frames 410, 420, and 430 may be implemented using HTML iframes, sections or divisions of a web page, or separate components of a native application.

Application frame 410 may interact with an interaction manager, such as interaction manager 323 of FIG. 3, to retrieve interactive software content. For example, application frame 410 may display fields 412, retrieved by the interaction manager, for gathering basic profile and financial information from a user.

Video frame 420 may interact with a media manager, such as media manager 324 of FIG. 3, to retrieve educational media relevant to the user. For example, video 422 may be retrieved by the media manager and used to provide explanation of the Employment Status and Other Income fields displayed in application frame 410. In embodiments, video frame 420 may include video content, audio content, text content, or any combination thereof.

Support frame 430 may interact with a support manager, such as support manager 325 of FIG. 3, to retrieve support content. For example, chat window 432 may provide technical or professional support to a user while interacting with application frame 410 and video frame 420. In an embodiment, the content displayed in support frame 430 may be provided by a third party service.

In an embodiment, a presenter, such as presenter 326 of FIG. 3, may aggregate retrieved interface content for display in a unified graphical user interface, such as interface 400. This enables a consumer, such as consumer 302 of FIG. 3, to operate service-specific software (e.g., financial planning or tax preparation software) while receiving step-by-step video guidance and access to live support personnel. In an embodiment, the presenter may also communicate information between interface components. For example, the current displayed application fields 412 may be communicated to a media manager in order to retrieve educational media associated with fields 412 for display in video frame 420.

### Example Method

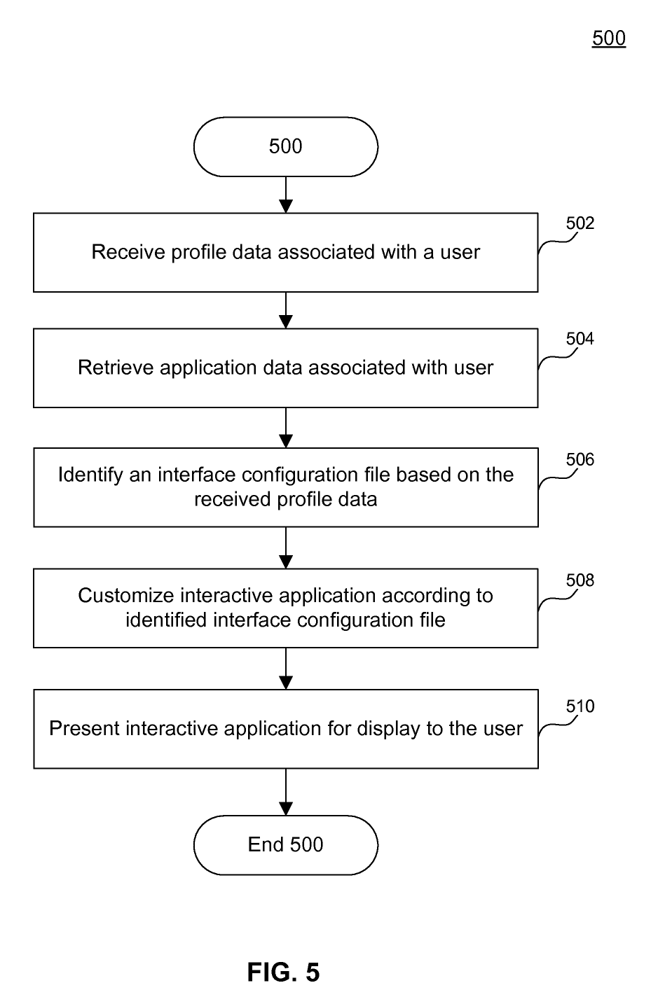

FIG. 5 is an example method 500 for accessing a collaborative software platform, according to an embodiment. Method 500 begins at stage 502 where profile data associated with a user may be received. User profile data may include various user preferences and demographics, for example and without limitation, age, gender, marital status, employment status, and income level.

At stage 504, application data associated with the user may be retrieved. In an embodiment, the application data is used to support an interactive application provided by the collaborative software platform. Application data may represent user inputs and outputs from previous interaction with the application, or application data may provide default data as a starting point for users. Application data may reside in an application database, such as application database 340 of FIG. 3.

At stage 506, at least one interface configuration file may be identified based on the received profile data. Each configuration file may be specify software tools, features, and/or interface pages to be available and displayed to the user. Configuration files may be formatted in any structured manner, such as in JavaScript Object Notation (JSON) or as an extensible markup language (XML) document.

At stage 508, the interactive application may be customized according to the identified interface configuration file. For example, in the case of financial planning software, when a retired consumer accesses the software, the consumer may have access to retirement cash flow planning tools but not estate planning tools. Additionally, the consumer may not be shown interface pages related to employment income as the user is retired. Finally, at stage 510, the interactive application is presented for display to the user. This customization based on interface configuration files allows the software to be targeted at different users without requiring modification to the software's core functionality.

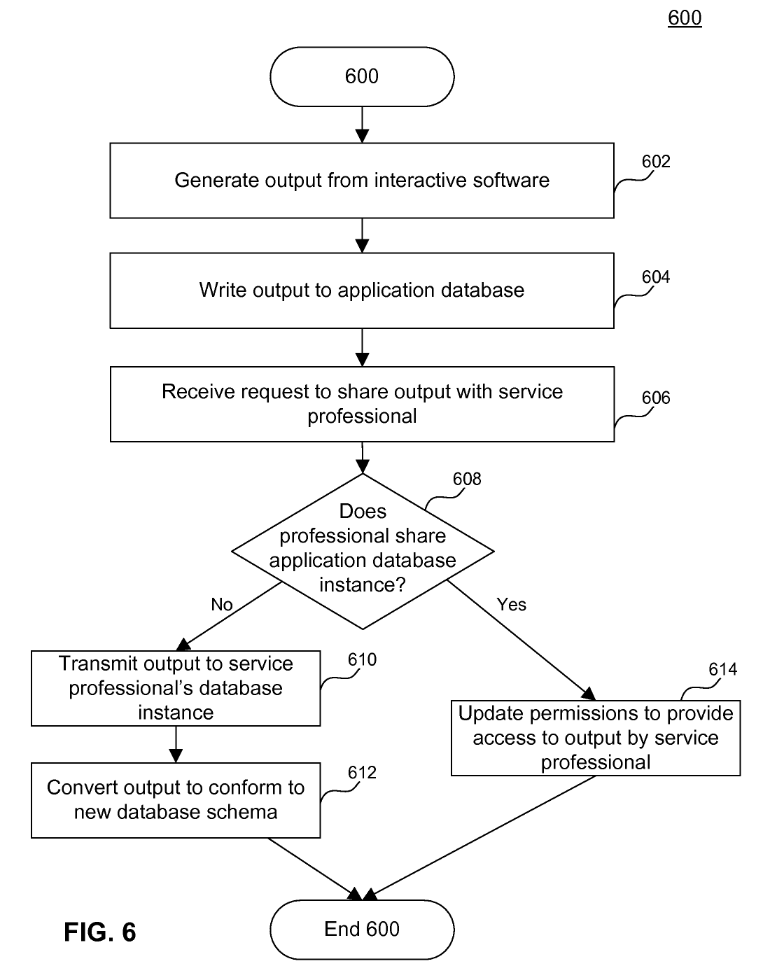

FIG. 6 is an example method 600 for sharing user data with a professional service provider, according to an embodiment. Method 600 begins at stage 602 when output from interactive software is generated for a user. For example, in the case of financial planning software, a financial plan may be generated as output from interaction with the software.

At stage 604, the resulting output is written to an application database, such as application database 340 of FIG. 3. At stage 606, a request may be received to share the resulting output with a service professional. For example, a user may initially generate a basic financial plan. The user may then choose to share this plan with a financial advisor in order to verify the accuracy of the results and receive further suggestions.

At stage 608, it is determined whether the service professional shares an application database instance with the user. In an embodiment, professional service providers may host private instances of the application database for increased security. If the service professional does not share an application database instance with the user, method 600 proceeds to stage 610.

At stage 610, the output (e.g., financial plan) may copy and transmit the output to the service professional's database instance. In an embodiment, the data may be serialized and encrypted for transmission. At stage 612, if the underlying data schemas differ between the two application database instances, the output may be converted to conform to the service professional's database schema.

Returning to stage 608, if the user and service professional share an application database instance, method 600 proceeds to stage 614. In an embodiment, a single instance of the application database may service most or all users of the interactive software. The instance may be hosted across multiple servers or in a cloud environment in order to scale efficiently. At stage 614, permissions to the output stored in the application database may be updated to allow access by the service professional. For example, if the user shares a financial plan, database permissions may be updated to allow the service professional to access the shared financial plan.

### Example Embodiment

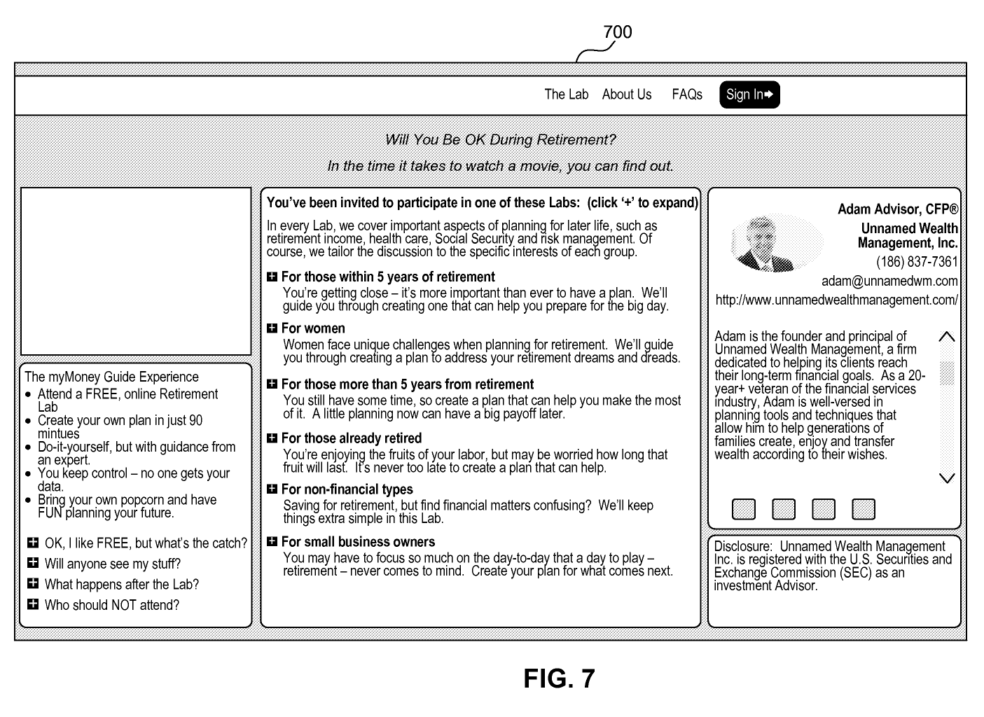

FIGS. 7-23 depict an example embodiment that provides tools for collaborative financial planning The embodiments depicted in FIGS. 7-18 are not intended to be limiting and are provided by way of example and explanation.

FIG. 7 is a diagram illustrating an example interface 700 for selecting a financial planning software lab, according to an embodiment. As described with respect to FIG. 3, according to an embodiment, a software lab offers consumers access to interactive software, instructional media, and support services during a scheduled period of time. Different labs may be designed for consumers of different types. For example, labs for those within five years of retirement and those more than five years from retirement may provide different recommendations to consumers for creating a financial plan.

Further, a financial planning software interface may be customized based on the type of lab chosen. For example, a lab for small business owners may include tools for entering small business assets, while other labs may hide that functionality by default. The software may be customized by an interaction manager, such as interaction manager 323 of FIG. 3. Interface 700 may be displayed as part of an administrative portal, such as administrative portal 330 of FIG. 3, by a presenter, such as presenter 326.

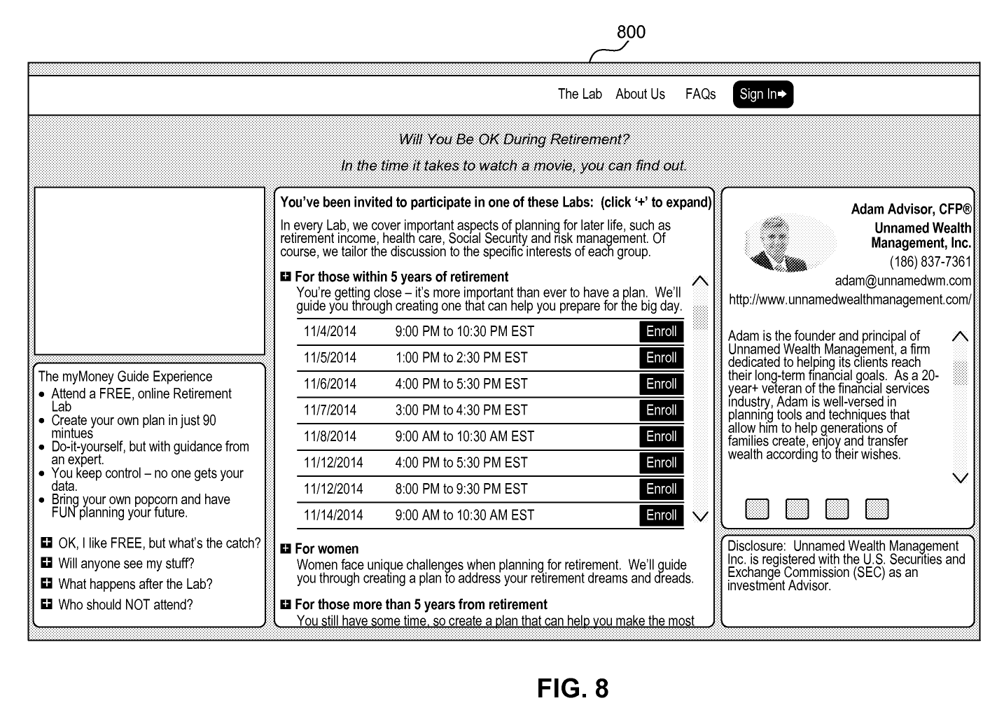

FIG. 8 is a diagram further illustrating an example interface 800 for scheduling a financial planning software lab, according to an embodiment. When a user selects a lab and a particular time, a scheduler, such as scheduler 335 of FIG. 3, may schedule the user as a participant of the lab. This information may be written to an administrative database, such as administrative database 350 of FIG. 3.

A user may then return at the time of the lab to begin creating a personalized financial plan. In an embodiment, a user may begin the lab up to 30 minutes before or after the scheduled start time. Interface 800 may be displayed as part of an administrative portal, such as administrative portal 330 of FIG. 3, by a presenter, such as presenter 326.

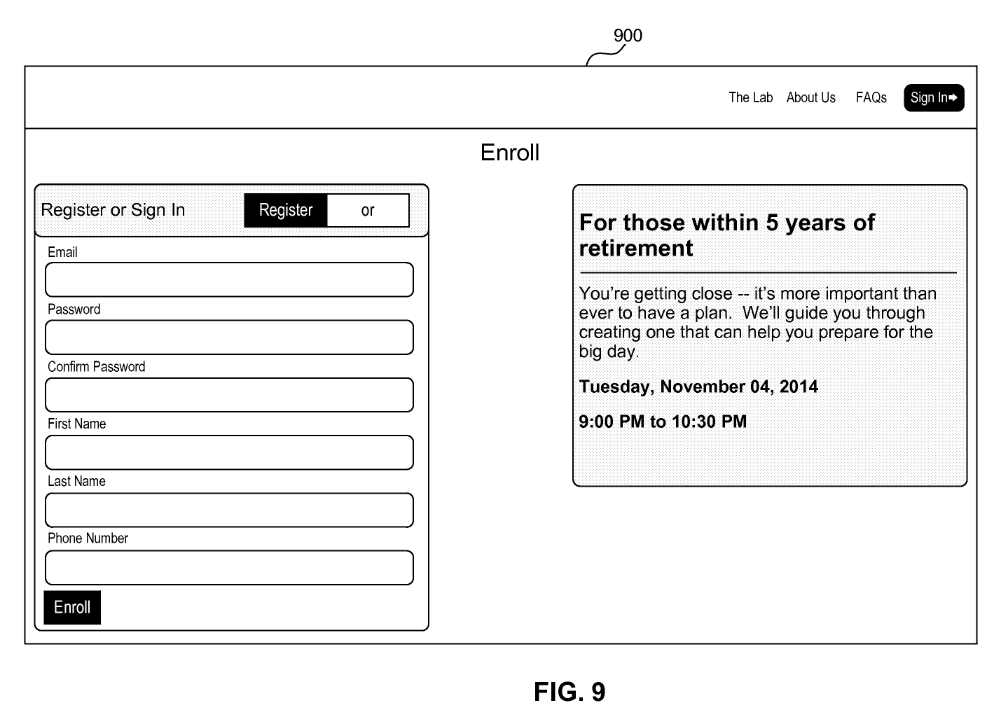

FIG. 9 is a diagram illustrating an example interface 900 for registering for a selected software lab, according to an embodiment. After selecting a software lab and time in an administrative portal, such as administrative portal 330 of FIG. 3, a user may create a registration with the portal. An authenticator, such as authenticator 333, may register the user for access to both the administrative portal and the software lab. Interface 900 may be displayed as part of an administrative portal, such as administrative portal 330 of FIG. 3, by a presenter, such as presenter 326.

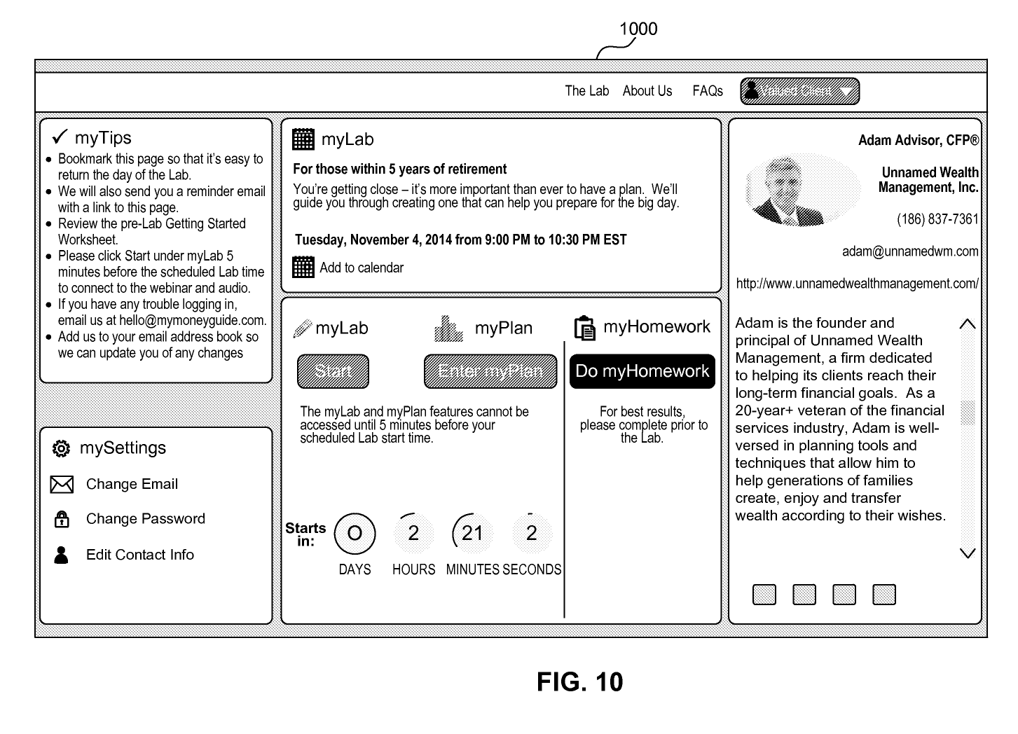

FIG. 10 is a diagram further illustrating an example interface 1000 for accessing a scheduled software lab, according to an embodiment. A user may also access a previously created financial plan via interface 1000. In an embodiment, if a user was referred by a service professional, general information about the professional may appear in interface 1000. Interface 1000 may be displayed as part of an administrative portal, such as administrative portal 330 of FIG. 3, by a presenter, such as presenter 326.

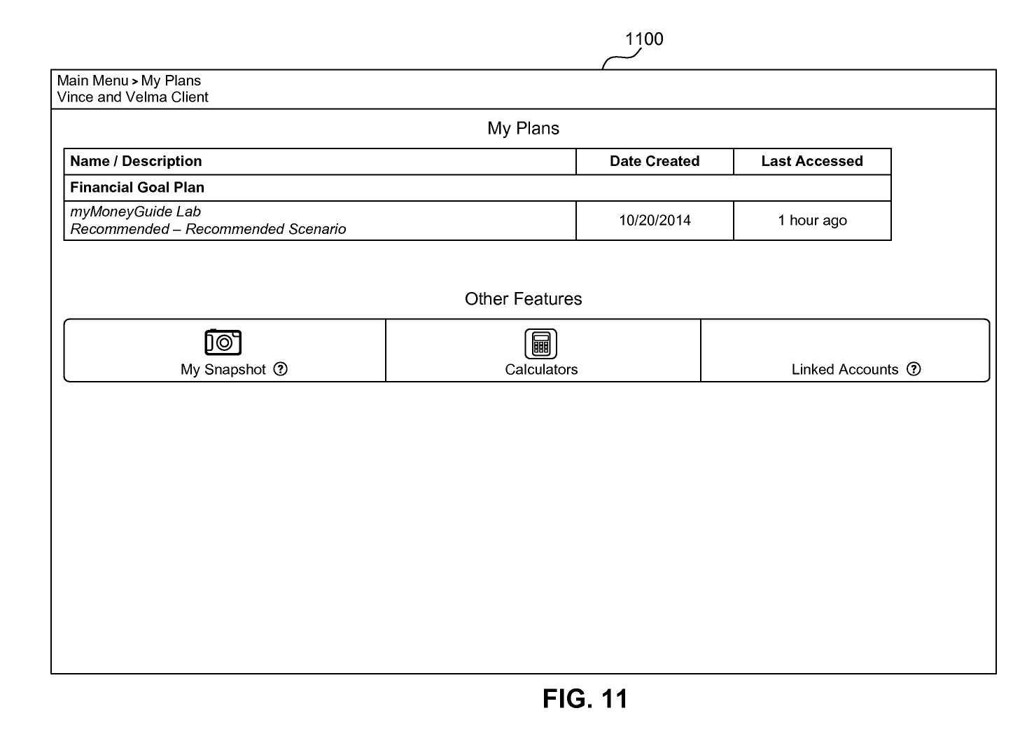

FIG. 11 is a diagram illustrating an example interface 1100 for creating and accessing a personalized financial plan, according to an embodiment. Interface 1100 may be integrated into a unified graphical user interface, such as interface 400 of FIG. 4, by a presenter, such as presenter 326 of FIG. 3. In an embodiment, interface 1100 may be displayed in application frame 410 of FIG. 4.

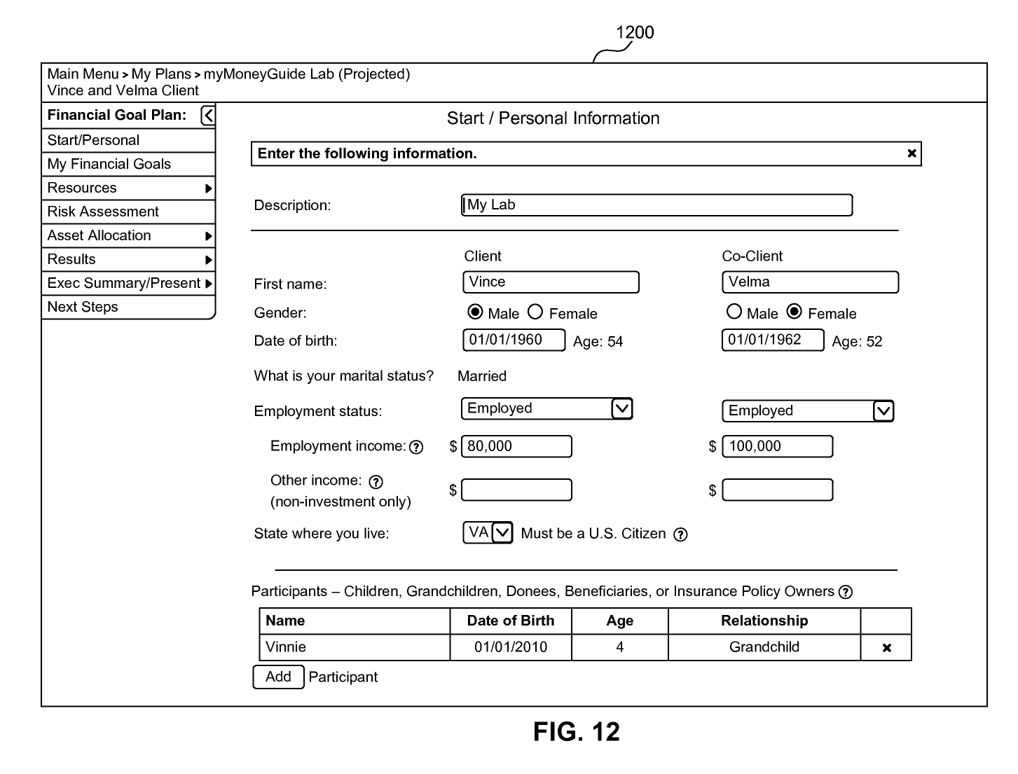

FIG. 12 is a diagram further illustrating an example interface 1200 for creating a personalized financial plan, according to an embodiment. Interface 1200 may enable a user to provide basic personal information, employment status, income and residence information. Interface 1200 may be integrated into a unified graphical user interface, such as interface 400 of FIG. 4, by a presenter, such as presenter 326 of FIG. 3. In an embodiment, interface 1200 may be displayed in application frame 410 of FIG. 4.

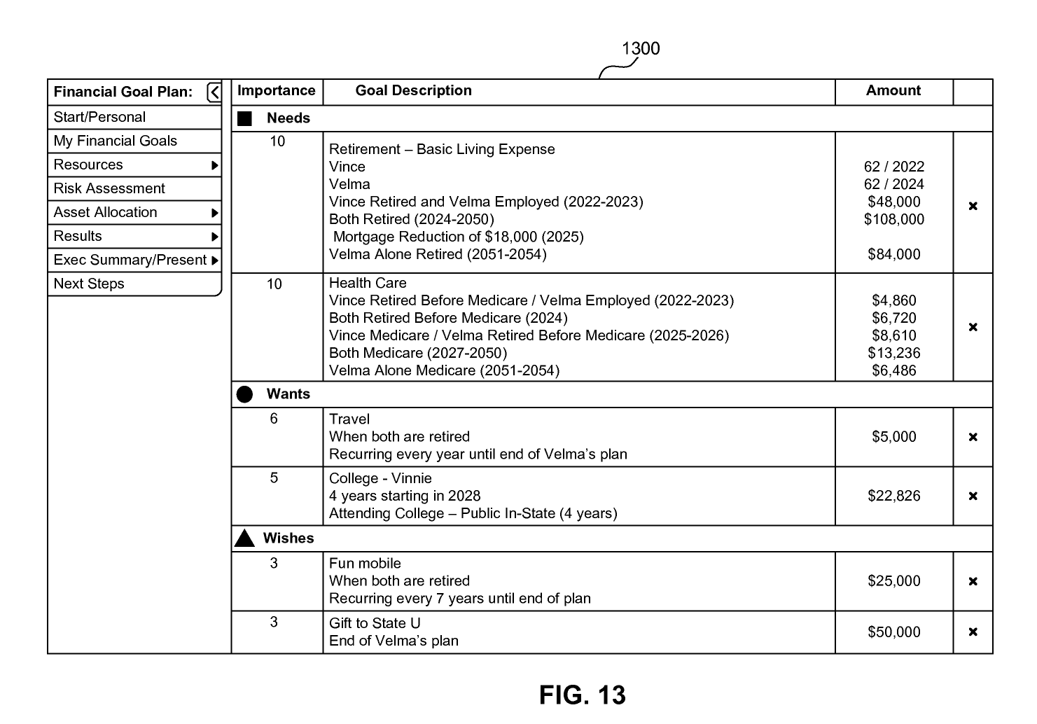

FIG. 13 is a diagram further illustrating an example interface 1300 for creating a personalized financial plan, according to an embodiment. Interface 1300 may enable a user to specify and prioritize short- and long-term financial goals. Interface 1300 may be integrated into a unified graphical user interface, such as interface 400 of FIG. 4, by a presenter, such as presenter 326 of FIG. 3. In an embodiment, interface 1300 may be displayed in application frame 410 of FIG. 4.

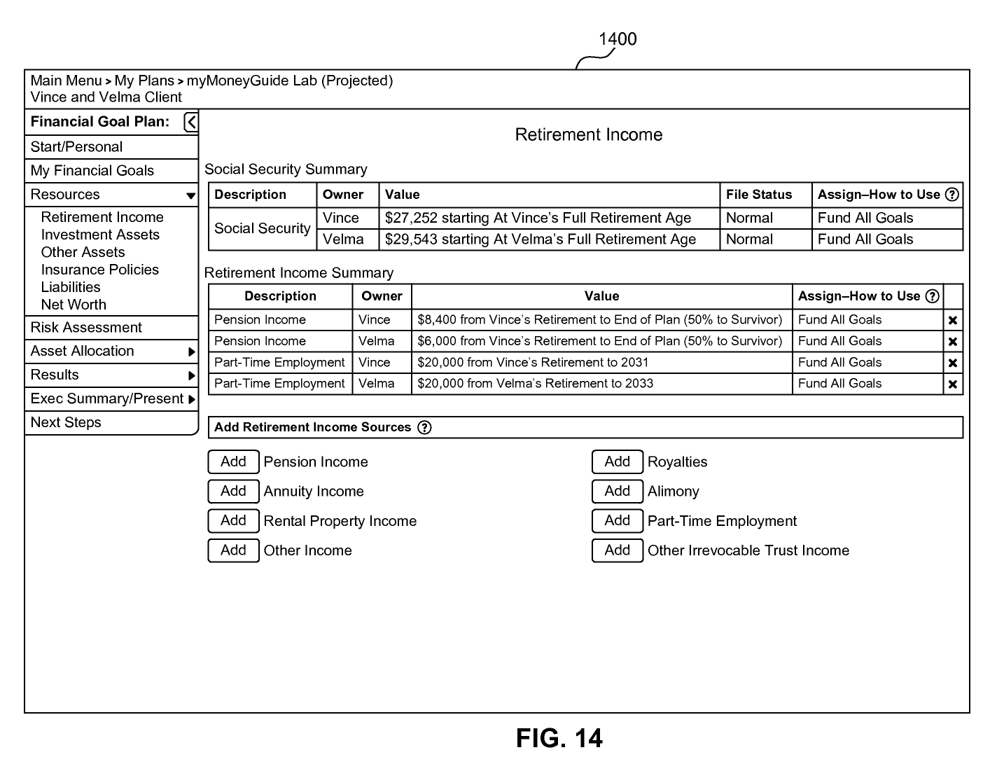

FIG. 14 is a diagram further illustrating an example interface 1400 for creating a personalized financial plan, according to an embodiment. Interface 1400 may provide tools for estimating available retirement income. Interface 1400 may be integrated into a unified graphical user interface, such as interface 400 of FIG. 4, by a presenter, such as presenter 326 of FIG. 3. In an embodiment, interface 1400 may be displayed in application frame 410 of FIG. 4.

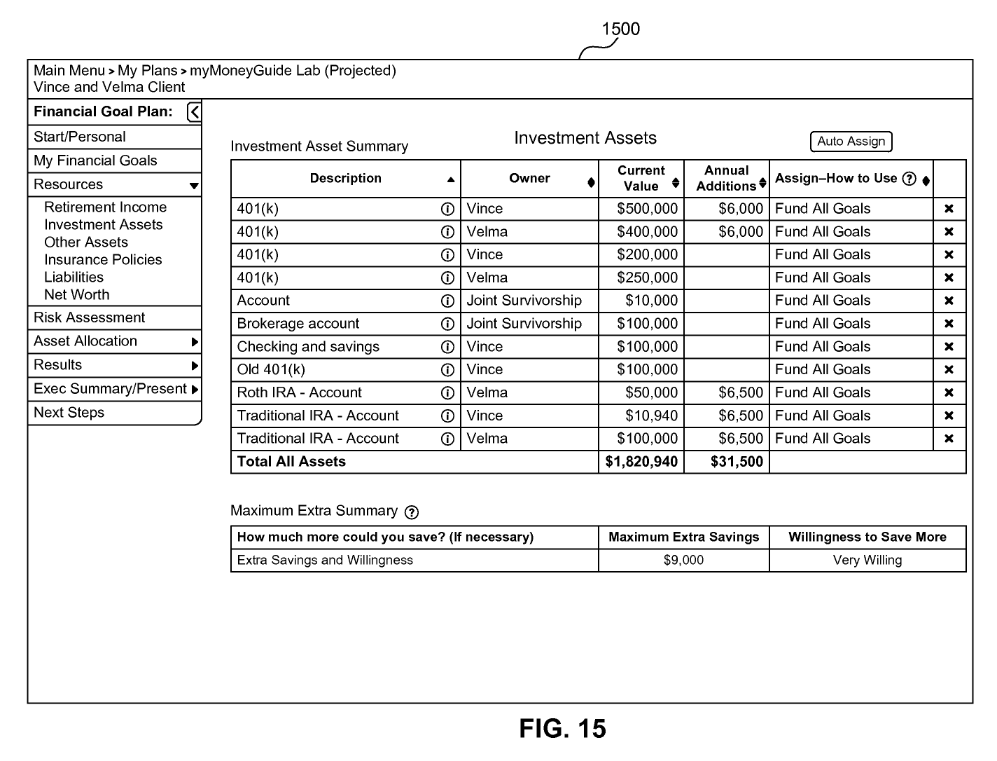

FIG. 15 is a diagram further illustrating an example interface 1500 for creating a personalized financial plan, according to an embodiment. Interface 1500 may enable a user to specify investment assets and estimate the future value of each asset. Interface 1500 may be integrated into a unified graphical user interface, such as interface 400 of FIG. 4, by a presenter, such as presenter 326 of FIG. 3. In an embodiment, interface 1500 may be displayed in application frame 410 of FIG. 4.

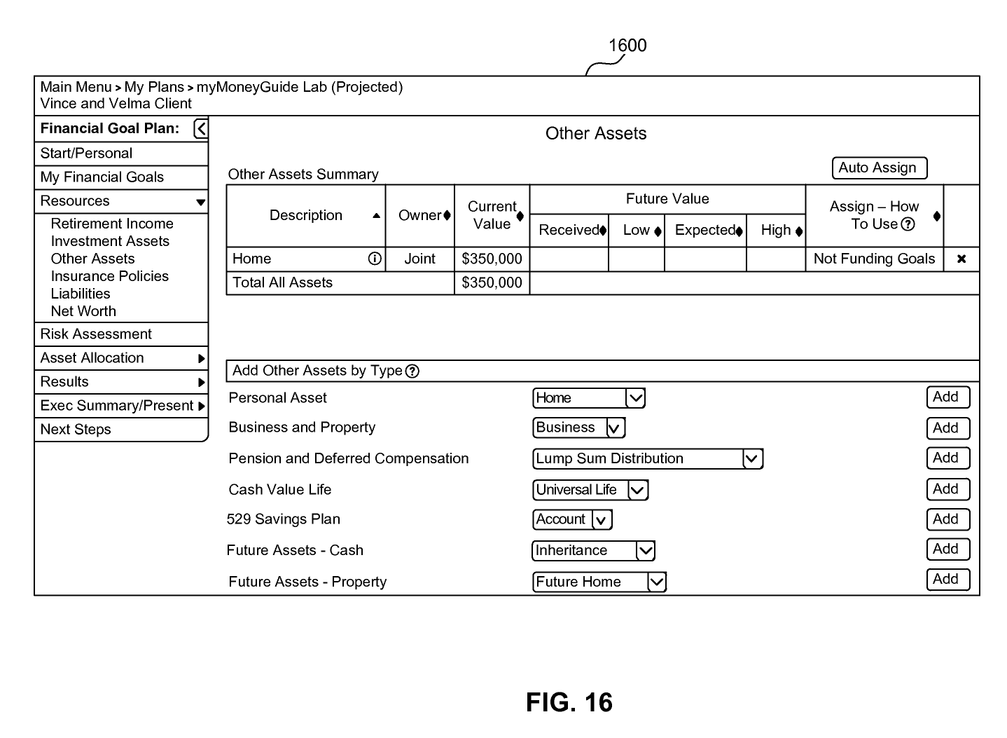

FIG. 16 is a diagram further illustrating an example interface 1600 for creating a personalized financial plan, according to an embodiment. Interface 1600 may enable a user to specify other assets, such as but not limited to, property and insurance policies. Interface 1600 may be integrated into a unified graphical user interface, such as interface 400 of FIG. 4, by a presenter, such as presenter 326 of FIG. 3. In an embodiment, interface 1600 may be displayed in application frame 410 of FIG. 4.

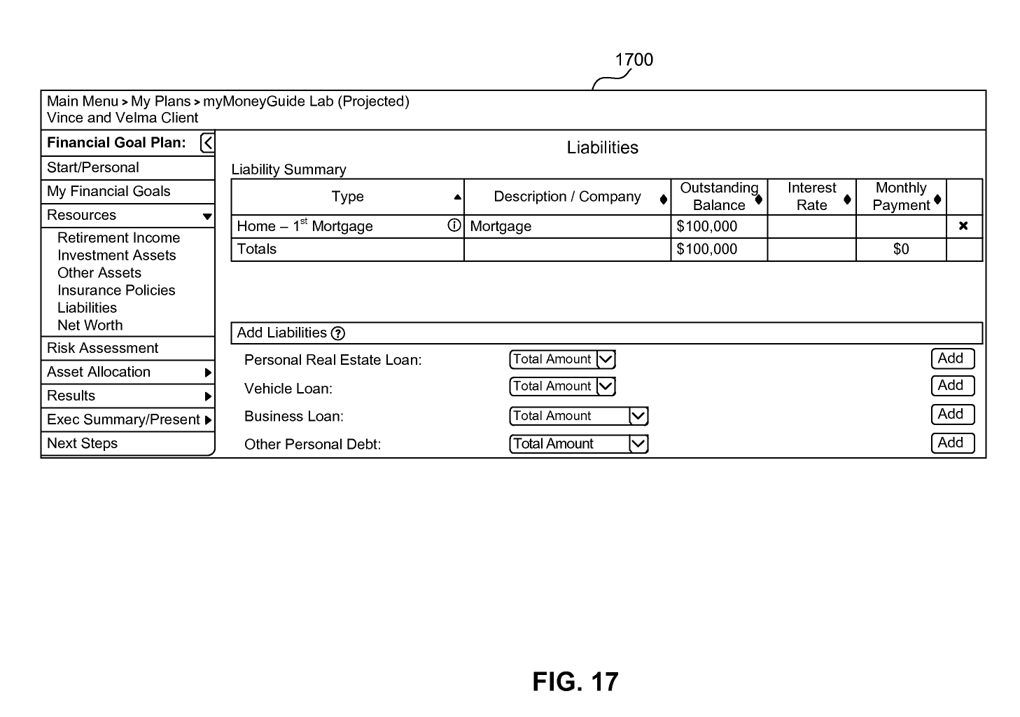

FIG. 17 is a diagram further illustrating an example interface 1700 for creating a personalized financial plan, according to an embodiment. Interface 1700 may enable a user to specify outstanding liabilities, such as but not limited to, a home mortgage or other outstanding loan. Interface 1700 may be integrated into a unified graphical user interface, such as interface 400 of FIG. 4, by a presenter, such as presenter 326 of FIG. 3. In an embodiment, interface 1700 may be displayed in application frame 410 of FIG. 4.

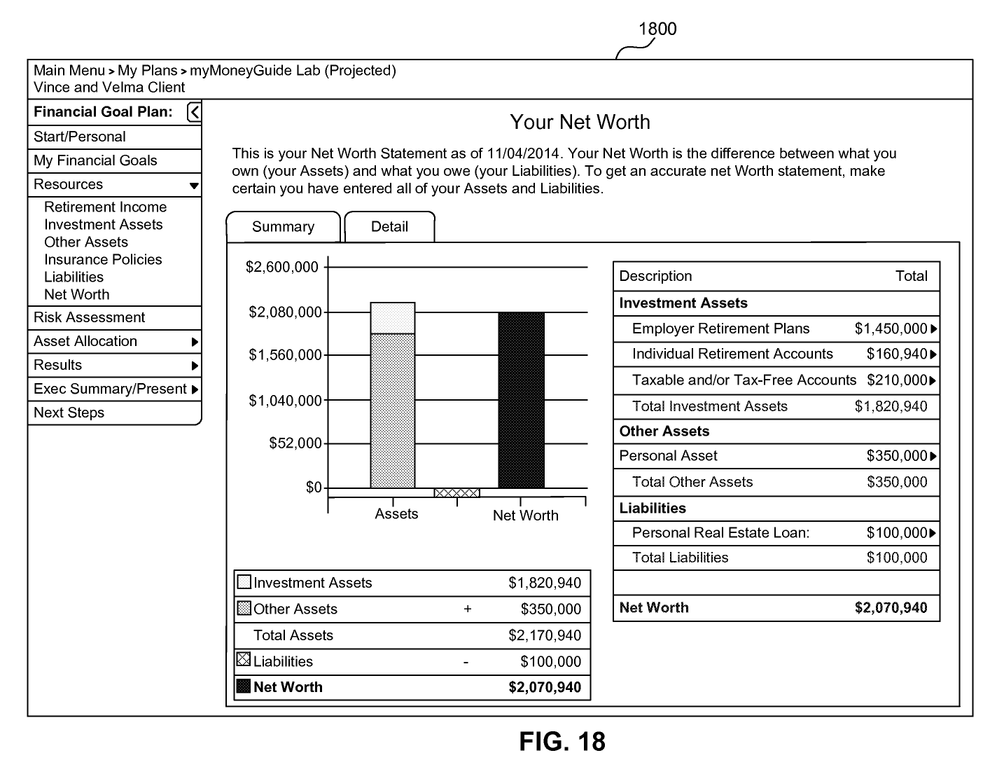

FIG. 18 is a diagram further illustrating an example interface 1800 for creating a personalized financial plan, according to an embodiment. Interface 1800 may provide analysis of a user's current net worth. Interface 1800 may be integrated into a unified graphical user interface, such as interface 400 of FIG. 4, by a presenter, such as presenter 326 of FIG. 3. In an embodiment, interface 1800 may be displayed in application frame 410 of FIG. 4.

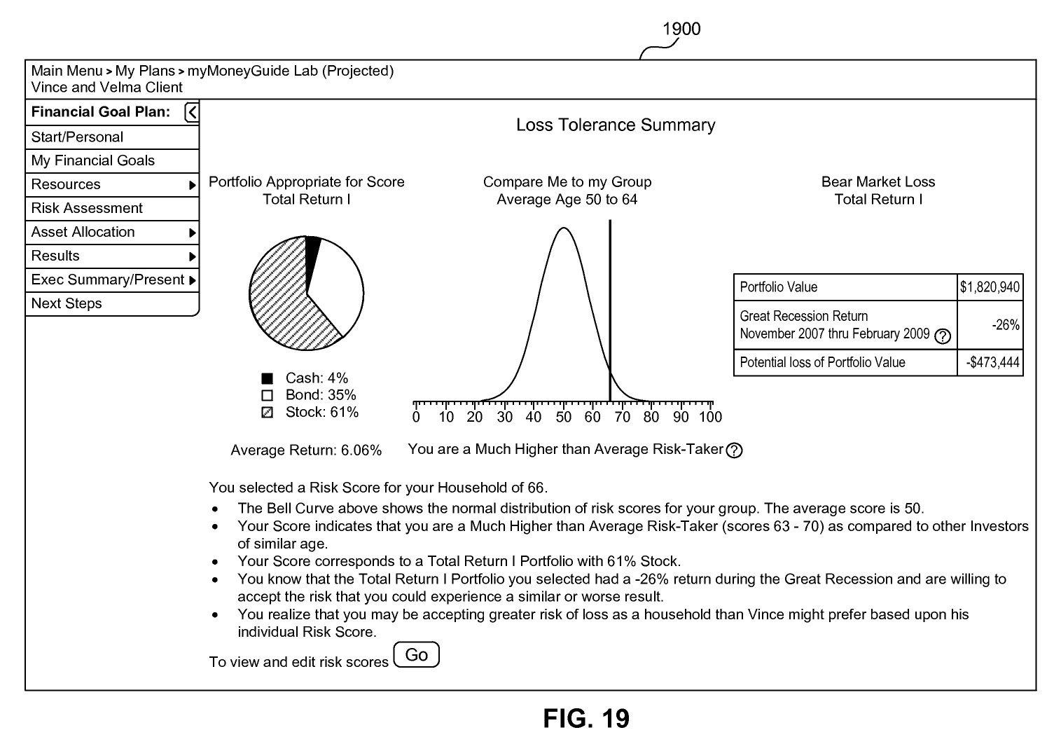

FIG. 19 is a diagram further illustrating an example interface 1900 for creating a personalized financial plan, according to an embodiment. Interface 1900 may provide analysis of a user's loss and risk tolerance. Interface 1900 may be integrated into a unified graphical user interface, such as interface 400 of FIG. 4, by a presenter, such as presenter 326 of FIG. 3. In an embodiment, interface 1900 may be displayed in application frame 410 of FIG. 4.

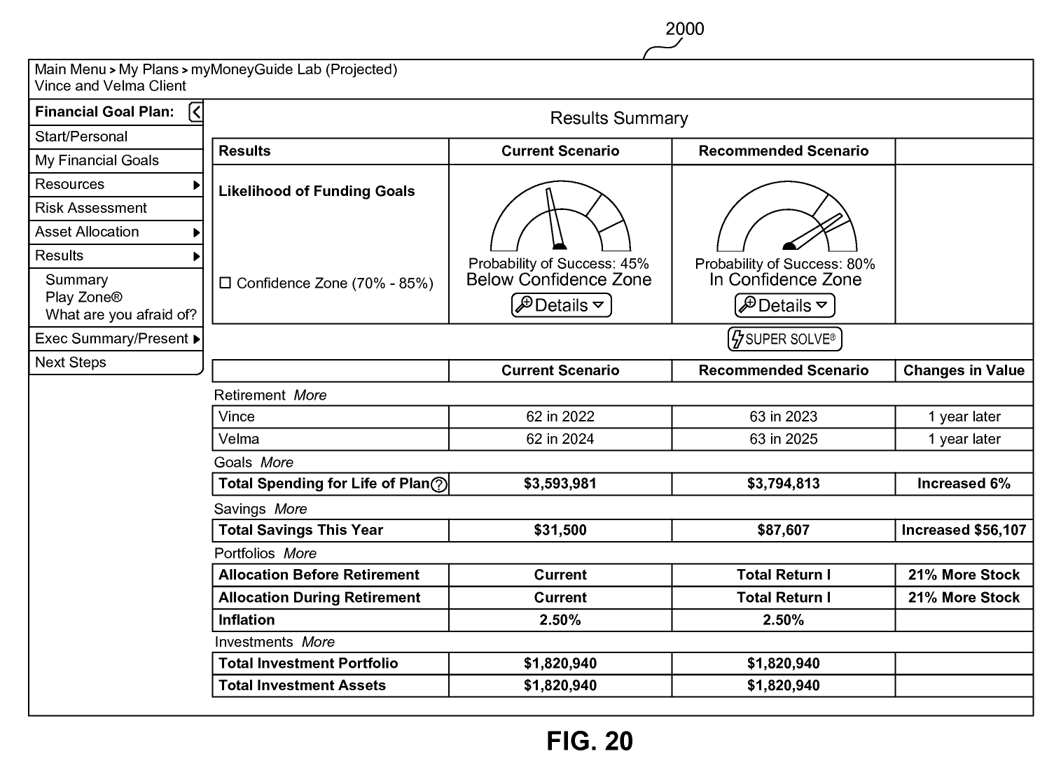

FIG. 20 is a diagram further illustrating an example interface 2000 for creating a personalized financial plan, according to an embodiment. Interface 20 may provide a summary of current results and potential results yielded by implementing recommended changes. For example, the financial planning tools depicted in FIG. 20 may determine that extending a user's time to retirement by a year may significantly increase total retirement funds. Interface 2000 may be integrated into a unified graphical user interface, such as interface 400 of FIG. 4, by a presenter, such as presenter 326 of FIG. 3. In an embodiment, interface 2000 may be displayed in application frame 410 of FIG. 4.

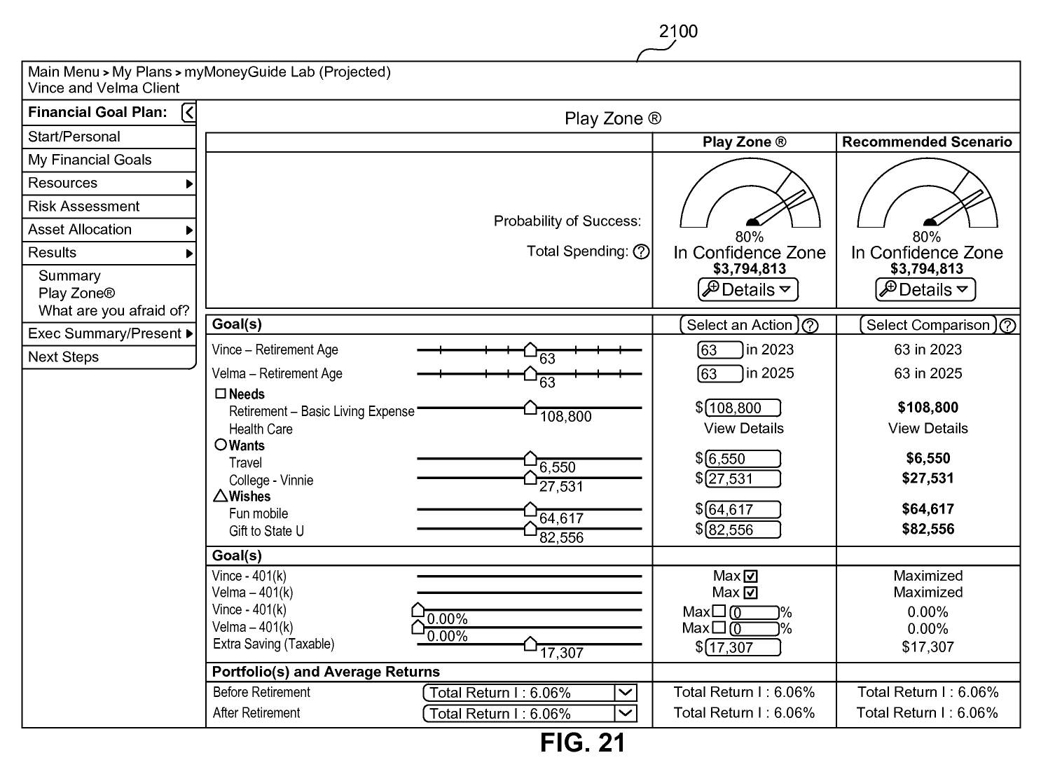

FIG. 21 is a diagram further illustrating an example interface 2100 for creating a personalized financial plan, according to an embodiment. Interface 21 may provide tools for adjusting inputs and dynamically recalculating financial results. For example, a user may adjust his year of retirement or savings goals and immediately view the effects of the change. Interface 2100 may be integrated into a unified graphical user interface, such as interface 400 of FIG. 4, by a presenter, such as presenter 326 of FIG. 3. In an embodiment, interface 2100 may be displayed in application frame 410 of FIG. 4.

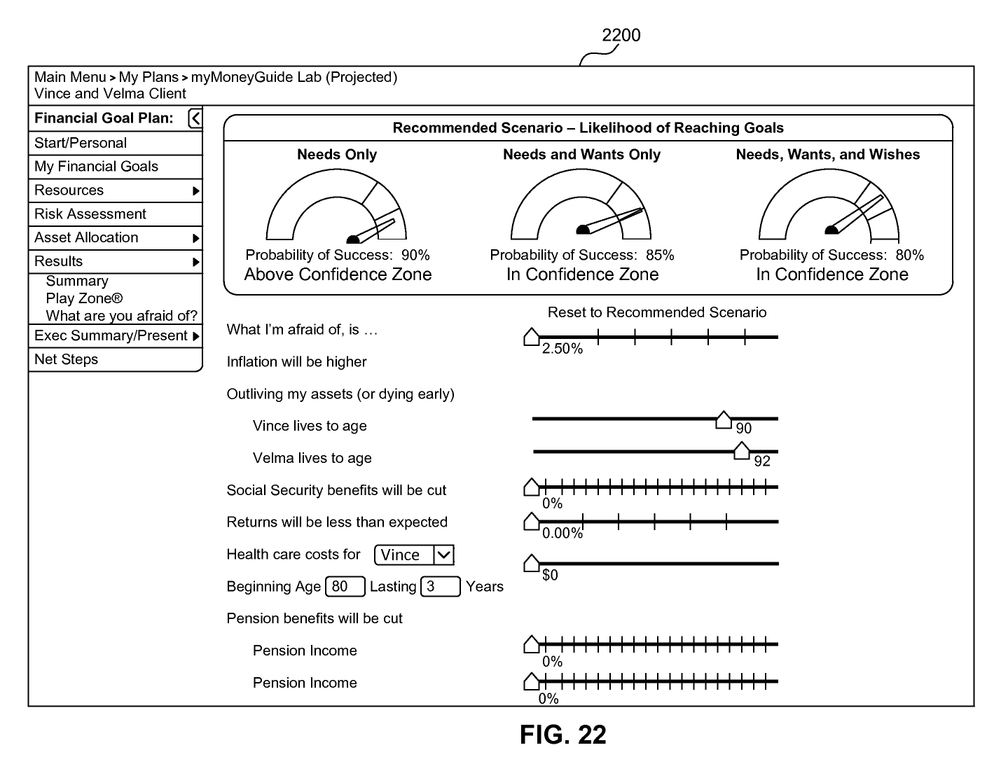

FIG. 22 is a diagram further illustrating an example interface 2200 for creating a personalized financial plan, according to an embodiment. Interface 2200 provides tools for taking into account particular scenarios, such as outliving assets or reductions in Social Security benefits. Interface 2200 may be integrated into a unified graphical user interface, such as interface 400 of FIG. 4, by a presenter, such as presenter 326 of FIG. 3. In an embodiment, interface 2200 may be displayed in application frame 410 of FIG. 4.

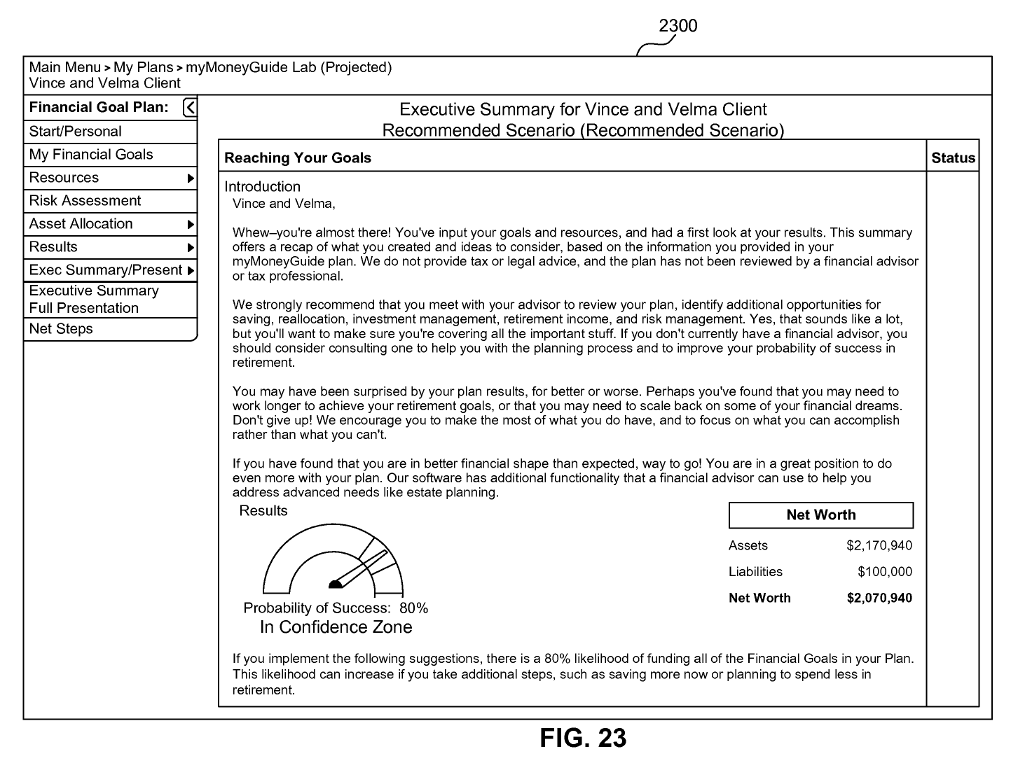

FIG. 23 is a diagram further illustrating an example interface 2300 for creating a personalized financial plan, according to an embodiment. Interface 2300 provides a summary of a user's probability of success in relation to his or her goals based on a created financial plan. Interface 2300 may be integrated into a unified graphical user interface, such as interface 400 of FIG. 4, by a presenter, such as presenter 326 of FIG. 3. In an embodiment, interface 2300 may be displayed in application frame 410 of FIG. 4.

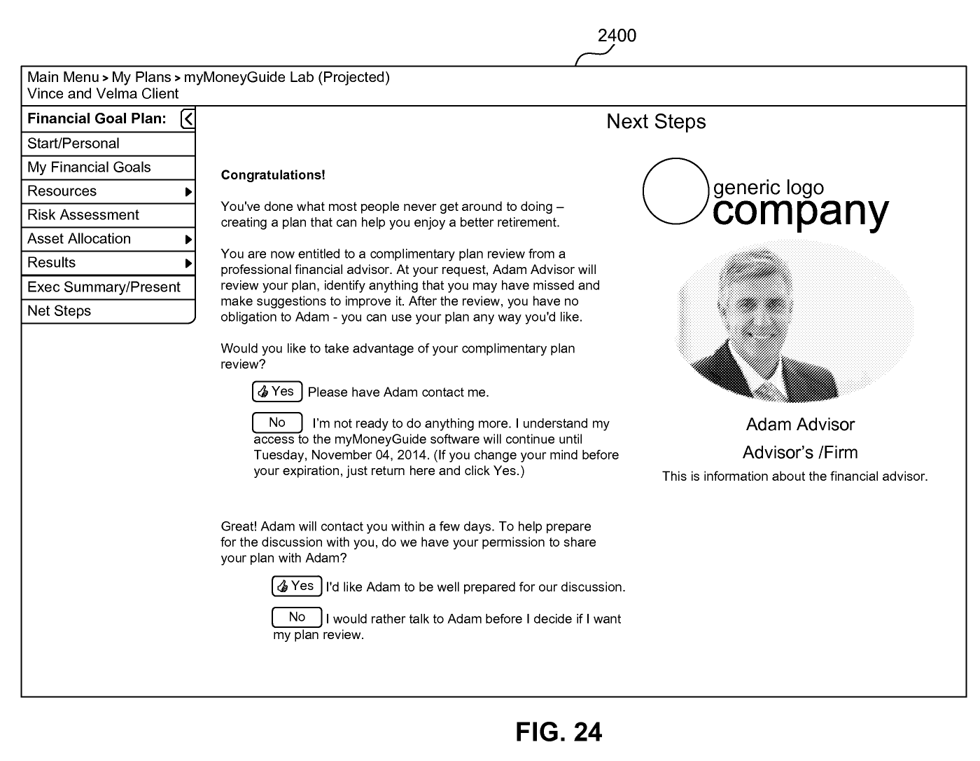

FIG. 24 is a diagram illustrating an example interface 2400 for initiating collaboration with a professional services provider, according to an embodiment. As described with respect to FIG. 3, a consumer may decide to share a created financial plan with a financial advisor for review and further modification. Interface 2400 enables a user to initiate sharing with a particular service professional. In an embodiment, the service professional may then have access to the consumer's financial plan through a collaborative software platform, such as collaborative software platform 320 of FIG. 3. Interface 2400 may be displayed as part of an administrative portal, such as administrative portal 330 of FIG. 3, by a presenter, such as presenter 326.

### Example Computer System

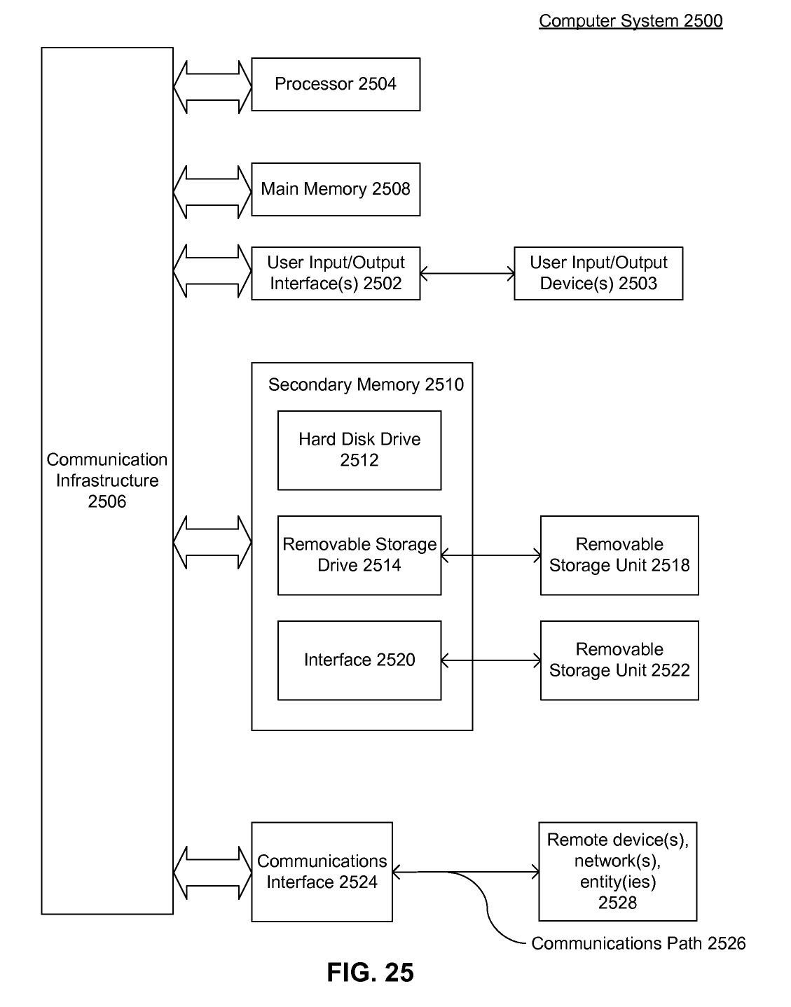

FIG. 25 is a diagram illustrating an example computing system useful for implementing various embodiments. Various embodiments can be implemented, for example, using computer system 2500. Computer system 2500 can be any computer specially programmed to perform the functions described herein, such as computers available from International Business Machines, Apple, Sun, HP, Dell, Sony, Toshiba, etc.

Computer system 2500 includes one or more processors (also called central processing units, or CPUs), such as a processor 2504. Processor 2504 may be connected to a communication infrastructure or bus 2506.

One or more processors 2504 may each be a graphics processing unit (GPU). In an embodiment, a GPU is a processor that is a specialized electronic circuit designed to rapidly process mathematically intensive applications on electronic devices. The GPU may have a highly parallel structure that is efficient for parallel processing of large blocks of data, such as mathematically intensive data common to computer graphics applications, images and videos.

Computer system 2500 also includes user input/output device(s) 2503, such as monitors, keyboards, pointing devices, etc., which communicate with communication infrastructure 2506 through user input/output interface(s) 2502.

Computer system 2500 also includes a main or primary memory 2508, such as random access memory (RAM). Main memory 2508 may include one or more levels of cache. Main memory 2508 has stored therein control logic (i.e., computer software) and/or data.

Computer system 2500 may also include one or more secondary storage devices or memory 2510. Secondary memory 2510 may include, for example, a hard disk drive 2512 and/or a removable storage device or drive 2514. Removable storage drive 2514 may be a floppy disk drive, a magnetic tape drive, a compact disk drive, an optical storage device, tape backup device, and/or any other storage device/drive.

Removable storage drive 2514 may interact with a removable storage unit 2518.

Removable storage unit 2518 includes a computer usable or readable storage device having stored thereon computer software (control logic) and/or data. Removable storage unit 2518 may be a floppy disk, magnetic tape, compact disk, DVD, optical storage disk, and/or any other computer data storage device. Removable storage drive 2514 reads from and/or writes to removable storage unit 2518 in a well-known manner.

According to an exemplary embodiment, secondary memory 2510 may include other means, instrumentalities or other approaches for allowing computer programs and/or other instructions and/or data to be accessed by computer system 2500. Such means, instrumentalities or other approaches may include, for example, a removable storage unit 2522 and an interface 2520. Examples of the removable storage unit 2522 and the interface 2520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 2500 may further include a communication or network interface 2524. Communication interface 2524 enables computer system 2500 to communicate and interact with any combination of remote devices, remote networks, remote entities, etc. (individually and collectively referenced by reference number 2528). For example, communication interface 2524 may allow computer system 2500 to communicate with remote devices 2528 over communications path 2526, which may be wired and/or wireless, and which may include any combination of LANs, WANs, the Internet, etc. Control logic and/or data may be transmitted to and from computer system 2500 via communication path 2526.

In an embodiment, a tangible apparatus or article of manufacture comprising a tangible computer useable or readable medium having control logic (software) stored thereon is also referred to herein as a computer program product, program storage device, or computer-readable storage device. This includes, but is not limited to, computer system 2500, main memory 2508, secondary memory 2510, and removable storage units 2518 and 2522, as well as tangible articles of manufacture embodying any combination of the foregoing. Such control logic, when executed by one or more data processing devices (such as computer system 2500), causes such data processing devices to operate as described herein.

Based on the teachings contained in this disclosure, it will be apparent to persons skilled in the relevant art(s) how to make and use the inventions using data processing devices, computer systems and/or computer architectures other than that shown in FIG. 25. In particular, embodiments may operate with software, hardware, and/or operating system implementations other than those described herein.

### CONCLUSION

Identifiers, such as “(a),” “(b),” “(i),” “(ii),” etc., are sometimes used for different elements or steps. These identifiers are used for clarity and do not necessarily designate an order for the elements or steps.

Embodiments of the present inventions have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of specific embodiments will so fully reveal the general nature of the inventions that others can, by applying knowledge within the skill of the art, readily modify and/or adapt for various applications such specific embodiments, without undue experimentation, without departing from the general concept of the present inventions. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present inventions should not be limited by any of the above-described embodiments, but should be defined only in accordance with the following claims and their equivalents.

What is claimed is:

1. A system for providing a collaborative software platform to support professional services, comprising:
one or more computing devices;
an application database configured to store user-specific data used to support an interactive application provided by the collaborative software platform;
a query manager, implemented on the one or more computing devices, configured to retrieve application data associated with a user from the application database. an interaction manager, implemented on the one or more computing devices, configured to:
receive profile data associated with the user;
identify an interface configuration file based on the received profile data; and
customize the interactive application according to the identified interface configuration file, wherein the customized interactive application includes software tools, features, and interface pages targeted at the user; and
a presenter, implemented on the one or more computing devices, configured to present the interactive application for display to the user.

2. The system of claim 1, further comprising:
a media manager, implemented on the one or more computing devices, configured to:
receive a state of the interactive software from the interaction manager; and
retrieve educational media based on the received state of the interactive software.

3. The system of claim 2, wherein the educational media comprises at least one of streaming video and streaming audio.

4. The system of claim 2, further comprising:
a support manager, implemented on the one or more computing devices, configured to connect the user to a technical support professional,
wherein the presenter is further configured to aggregate content retrieved by the interaction manager, the media manager, and the support manager into a single graphical user interface.

5. The system of claim 1, wherein the profile data includes at least one of user preference data and user demographic data;

6. The system of claim 1, wherein the interface configuration file specifies software tools, features, and interface pages to be displayed to the user;

7. The system of claim 1, wherein the interface configuration file is formatted in JavaScript Object Notation (JSON).

8. A method for providing a collaborative software platform to support professional services, comprising:
receiving profile data associated with a user;
retrieving application data associated with the user from an application database, wherein the application database stores user-specific data used to support an interactive application provided by the collaborative software platform;
identifying an interface configuration file based on the received profile data;
customizing the interactive application according to the identified interface configuration file, wherein the customized interactive application includes software tools, features, and interface pages targeted at the user; and
presenting the interactive application for display to the user;

9. The method of claim 8, further comprising:
receiving a current state of the interactive software; and
retrieving educational media based on the received state of the interactive software.

10. The method of claim 9, wherein the educational media comprises at least one of streaming video and streaming audio.

11. The method of claim 9, further comprising:
connecting the user to a technical support professional,
wherein the presenting further comprises displaying the interactive software, the retrieved educational media, and technical support content in a single graphical user interface.

12. The method of claim 8, wherein the profile data includes at least one of user preference data and user demographic data;

13. The method of claim 8, wherein the interface configuration file specifies software tools, features, and interface pages to be displayed to the user;

14. The method of claim 8, wherein the interface configuration file is formatted in JavaScript Object Notation (JSON).

15. A non-transitory computer-readable storage device having instructions stored thereon that, when executed by at least one computing device, causes the at least one computing device to perform operations comprising:
receiving profile data associated with a user;
retrieving application data associated with the user from an application database, wherein the application database stores user-specific data used to support an interactive application provided by the collaborative software platform;
identifying an interface configuration file based on the received profile data;
customizing the interactive application according to the identified interface configuration file; and
presenting the interactive application for display to the user;

16. The non-transitory computer-readable storage device of claim 15, further comprising:
receiving a current state of the interactive software; and
retrieving educational media based on the received state of the interactive software.

17. The non-transitory computer-readable storage device of claim 16, wherein the educational media comprises at least one of streaming video and streaming audio.

18. The non-transitory computer-readable storage device of claim 16, further comprising:
connecting the user to a technical support professional,
wherein the presenting further comprises displaying the interactive software, the retrieved educational media, and technical support content in a single graphical user interface.

19. The non-transitory computer-readable storage device of claim 15, wherein the profile data includes at least one of user preference data and user demographic data;

20. The non-transitory computer-readable storage device of claim 15, wherein the interface configuration file specifies software tools, features, and interface pages to be displayed to the user;

21. The non-transitory computer-readable storage device of claim 15, wherein the interface configuration file is formatted in JavaScript Object Notation (JSON).

22. A system for providing a collaborative software platform to support professional services, comprising:
means for receiving profile data associated with a user;
means for retrieving application data associated with the user from an application database, wherein the application database stores user-specific data used to support an interactive application provided by the collaborative software platform;
means for identifying an interface configuration file based on the received profile data;
means for customizing the interactive application according to the identified interface configuration file, wherein the customized interactive application includes software tools, features, and interface pages targeted at the user; and
means for presenting the interactive application for display to the user;
